(19) United States
(12) Patent Application Publication
(10) Pub. No.: US 2025/0019923 A1
(43) Pub. Date: Jan. 16, 2025

(54) METHOD AND SYSTEM FOR CONTROLLING FLOWABLE MATERIAL

(71) Applicant: Gerald J. NORCOTT, Kitchener (CA)

(72) Inventor: Gerald J. NORCOTT, Kitchener (CA)

(21) Appl. No.: 18/768,093

(22) Filed: Jul. 10, 2024

Related U.S. Application Data
(60) Provisional application No. 63/513,023, filed on Jul. 11, 2023.

(51) Int. Cl. E02F 3/407; B65G 53/34; E01H 10/00

(52) U.S. Cl. CPC E02F 3/407; B65G 53/34; E01H 10/007

(57) ABSTRACT

A system for directing flowable material to one or more preselected locations. The system includes a loader bucket with a body having a chute located at a closed end of the body, extending between an inner chute opening at the internal surface and an outer chute opening at an external surface of the body. The system includes a bucket assembly including a screen positioned in the body to define a heel portion of the bucket volume. The bucket assembly includes an auger subassembly at least partially located in the heel portion, for moving the flowable material in the heel portion to the inner chute opening, and a chute cover. The chute cover is movable between a closed position, in which the chute cover prevents the flowable material from flowing through the chute, and an open position, in which movement of the flowable material is permitted.

### CROSS-REFERENCE TO RELATED APPLICATION

This application claims the benefit of U.S. Provisional Patent Application No. 63/513,023, filed on Jul. 11, 2023, the entirety of which provisional patent application is hereby incorporated herein be reference.

### FIELD OF THE INVENTION

The present invention is a system and a method for controlling flowable material.

### BACKGROUND OF THE INVENTION

In the prior art, flowable or bulk material is often controlled by manual effort, or otherwise via somewhat cumbersome methods. For example, sand bags are often filled by hand. Although machines for filling sand bags are known, the known machines are generally designed for filling several sand bags at the same time.

There are also many circumstances in residential and commercial construction in which bulk material is conventionally manually distributed, or is distributed using highly specialized equipment, such as a stone slinger.

Similarly, the conventional methods of clearing snow off a parking lot or other road surface and then distributing sand or road salt thereon are somewhat cumbersome. First, the snow is removed, e.g., by a front end loader or a truck with a plow mounted on it. The salt may be loaded by a loader into a box on a specially modified truck from which the salt is allowed to fall, onto a spinner that rotates as the truck moves along the road on which the road salt is to be spread.

### SUMMARY OF THE INVENTION

For the foregoing reasons, there is a need for a method and system for controlling flowable material that overcomes or mitigates one or more of the defects or deficiencies of the prior art.

In its broad aspect, the invention provides a system for directing flowable material to one or more preselected locations. The system includes a loader bucket having a body with a chute located at a closed end of the body. The body has one or more internal surfaces that define a bucket volume. The chute extends between an inner chute opening at the internal surface and an outer chute opening at an external surface. The system also includes a bucket assembly that is mounted to the loader bucket. The bucket assembly includes a screen positioned in the body and defining a heel portion of the bucket volume that is between the screen and the internal surface at the closed end.

The bucket assembly also includes an auger subassembly that is at least partially located in the heel portion, for moving the flowable material in the heel portion to the inner chute opening. The bucket assembly also includes a chute cover that is movable between a closed position, in which the cute cover prevents the flowable material from flowing through the chute, and an open position, in which movement of the flowable material through the chute is permitted. The loader bucket is positionable to locate the outer chute opening above the preselected location, so that the flowable material may be directed onto the preselected location from the outer chute opening.

### BRIEF DESCRIPTION OF THE DRAWINGS

The invention will be better understood with reference to the attached drawings, in which:

FIG. 1A is a partial cross-section of an embodiment of a system of the invention, in which a floor element of the bucket assembly is shown in a lowered position;

FIG. 1B is a cross-section of a body of a loader bucket included in the system of FIG. 1A;

FIG. 1C is a partial cross-section of the bucket assembly of FIG. 1A in which the floor element is shown in a raised position;

FIG. 1D is an isometric view of a portion of an embodiment of a floor element hinge subassembly;

FIG. 1E is an isometric view of a portion of the system of FIGS. 1A and 1B in which a chute cover is positioned to cover an output end of a chute, drawn at a larger scale;

FIG. 1F is a partial cross-section of an alternative embodiment of the system of the invention;

FIG. 2A is a schematic illustration of the bucket assembly of FIGS. 1A and 1B, drawn at a smaller scale;

FIG. 2B is a schematic illustration of another embodiment of the bucket assembly of the invention;

FIG. 3 is an isometric view of the bucket assembly of FIGS. 1A and 1B in which the floor element is in a loader mode position thereof;

FIG. 4 is an isometric view of the bucket assembly of FIGS. 1A and 1B in which the floor element is in a distributor mode position thereof;

FIG. 5 is an isometric view of the bucket assembly of FIGS. 1A and 1B in which the bucket has a load of a flowable material therein;

FIG. 6A is a schematic illustration of an embodiment of the system of the invention;

FIG. 6B is a schematic illustration of another embodiment of the system of the invention;

FIG. 7A is a side view of the bucket with the chute cover held in an engaged position, drawn at a larger scale;

FIG. 7B is a side view of an embodiment of a spinner carriage subassembly of the invention in a fully lowered position, to locate a spinner wheel thereof below the chute;

FIG. 7C is an isometric view of the spinner carriage subassembly of FIG. 7B in a fully raised position;

FIG. 7D is an isometric view of the spinner carriage subassembly of FIGS. 7B and 7C in a first intermediate position; and

FIG. 7E is an isometric view of the spinner carriage subassembly of FIGS. 7B-7D in a second intermediate position.

### DETAILED DESCRIPTION

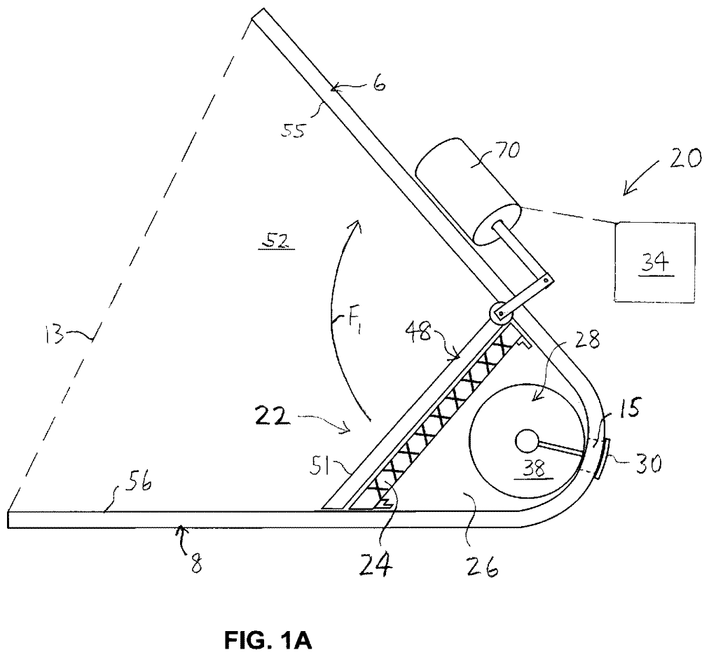

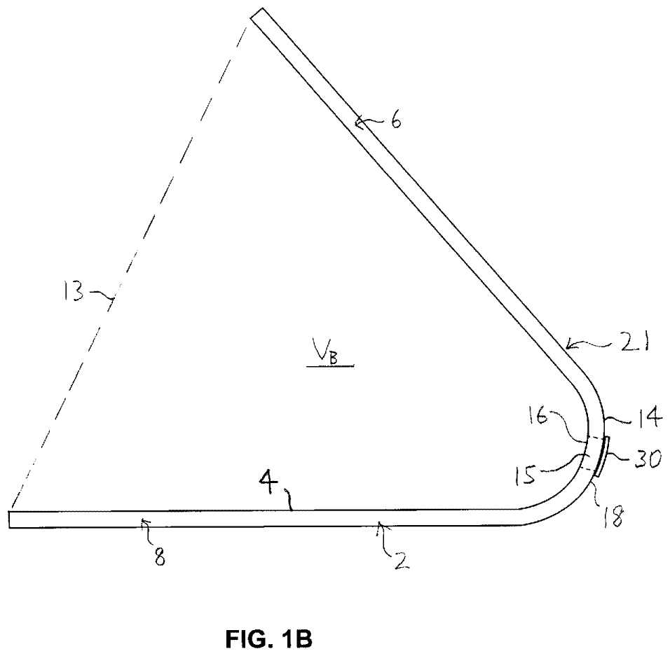

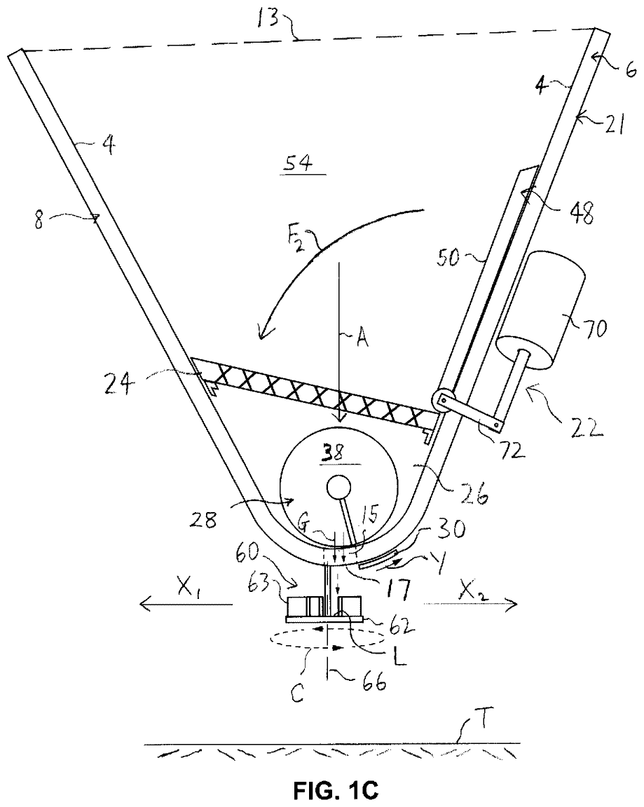

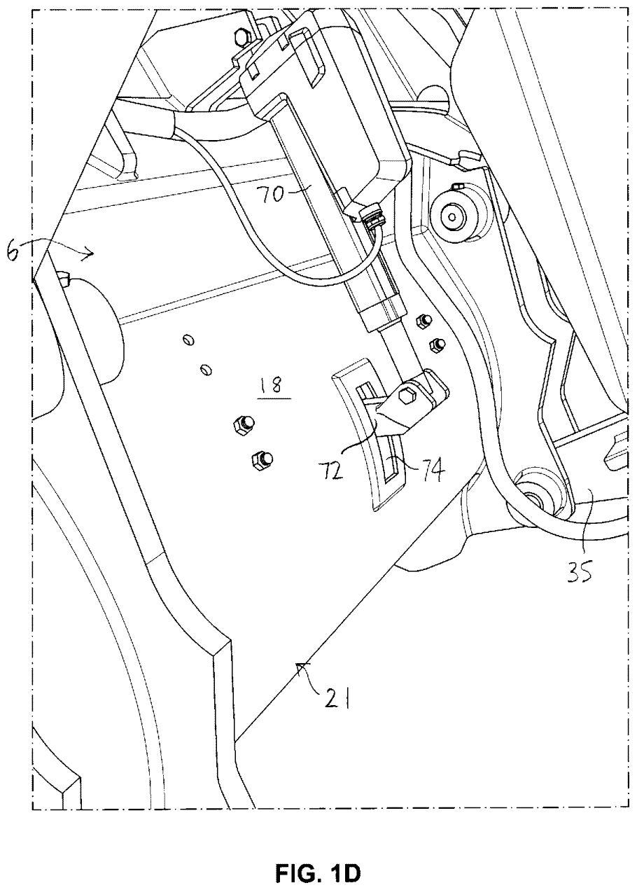

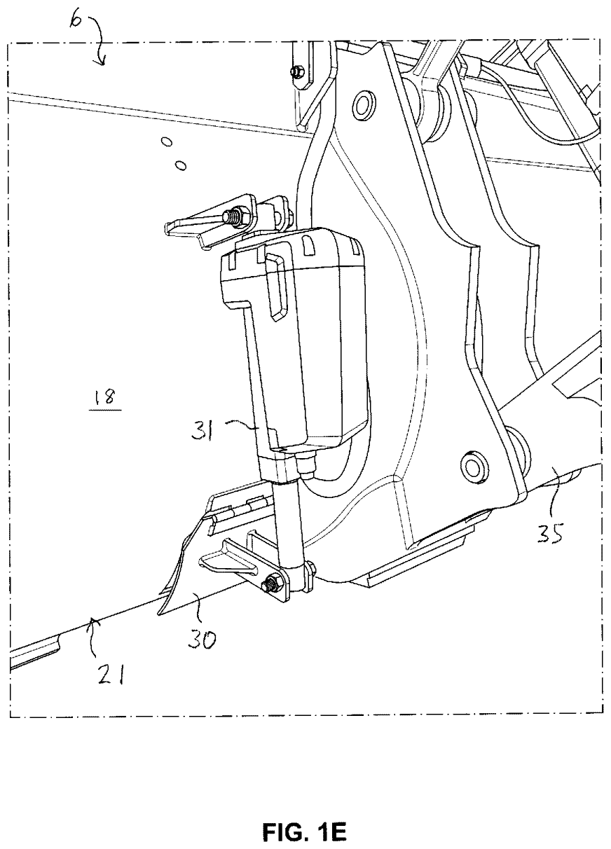

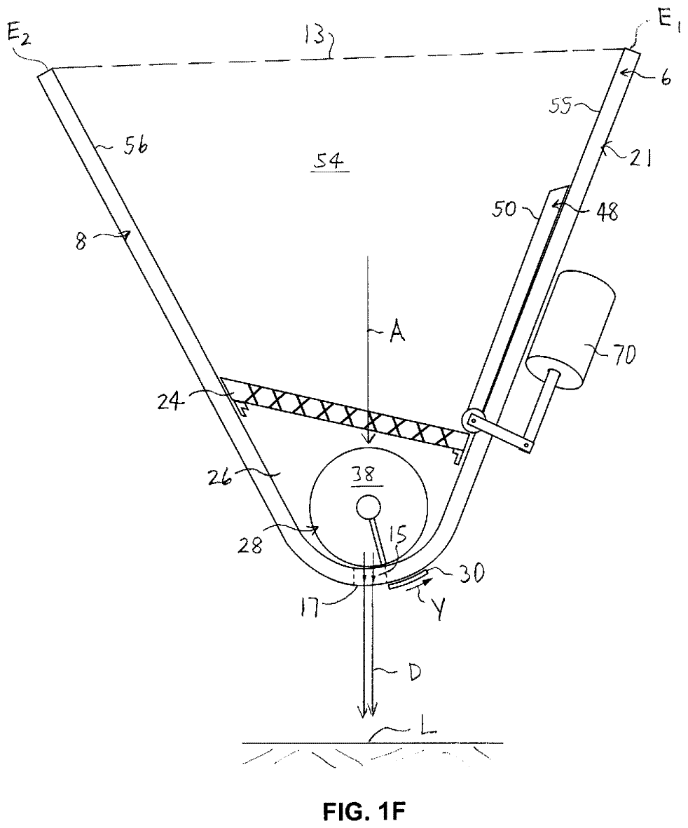

In the attached drawings, like reference numerals designate corresponding elements throughout. Reference is made to FIGS. 1A-7E to describe an embodiment of a system in accordance with the invention indicated generally by the numeral 20.

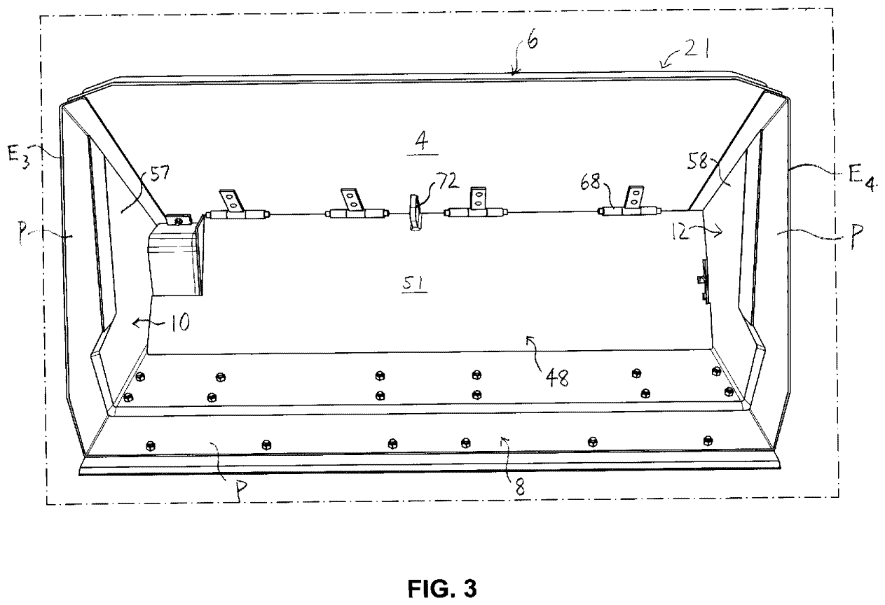

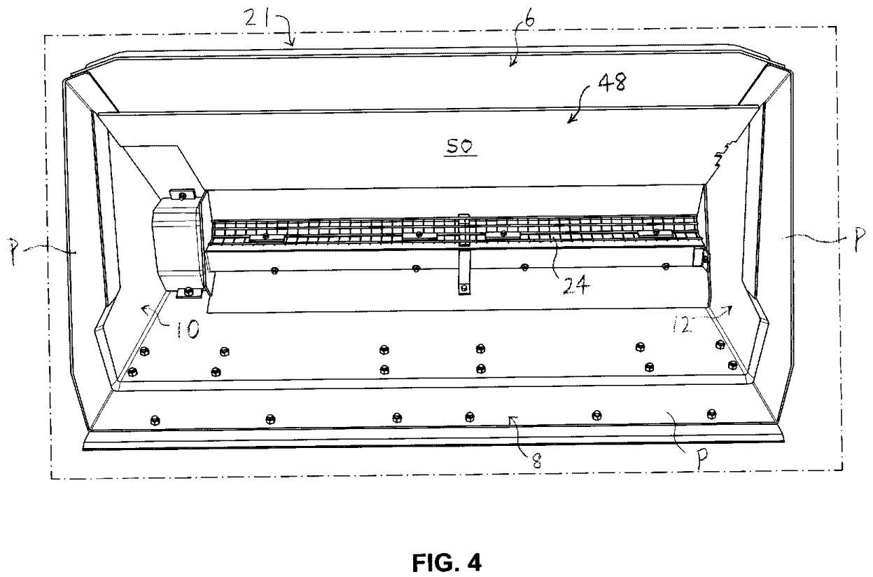

As will be described, the system 20 is for directing flowable material to one or more preselected locations “L” (FIG. 1F). Preferably, the system 20 includes a loader bucket 21 that has a body 2 with one or more internal surfaces 4 thereof defining a bucket volume “VB” (FIG. 1B). As can be seen in FIG. 1B, the body 2 includes upper and lower walls 6, 8 that are connected with first and second sidewalls 10, 12 (FIGS. 3, 4) and define an open end 13 and an opposed closed end 14 of the body 2.

In one embodiment, the body 2 preferably includes a chute 15 located at the closed end 14 and extending between inner and outer chute openings 16, 17 (FIGS. 1B, 1C) at the internal surface 4 and an opposed external surface 18 of the body 2 respectively. As will be described, the outer chute opening 17 has a preselected cross-sectional area that is sized for delivery of the flowable material therefrom to the preselected location(s) “L”.

As can be seen, e.g., in FIGS. 1A, 1B, and 1F, the system 20 preferably includes a bucket assembly 22 mounted to the loader bucket 21. The bucket assembly 22 preferably includes a screen 24 positioned in the body 2 that defines a heel portion 26 of the bucket volume “VB” between the screen 24 and the internal surface 4 of the body 2, at the closed end 14.

Preferably, the bucket assembly 22 also includes an auger subassembly 28 at least partially located in the heel portion 26, for moving the flowable material that is positioned in the heel portion 26 to the inner chute opening 16 (FIGS. 1A, 1C, 1F). It is also preferred that the bucket assembly 22 includes a chute cover 30 movable between a closed position thereof (FIGS. 1A, 1B), in which the chute cover 30 prevents the flowable material from flowing through the chute 15, and an open position thereof (FIGS. 1C, 1F), in which movement of the flowable material through the chute 15 is permitted thereby.

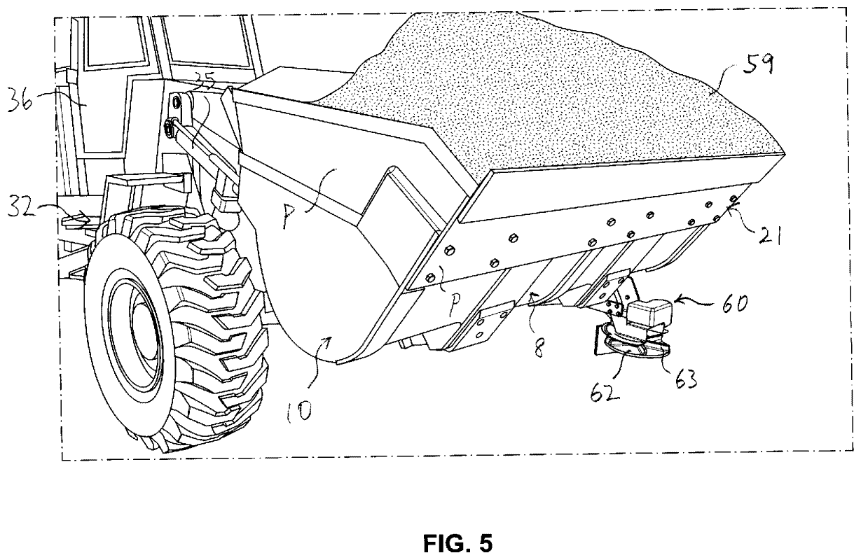

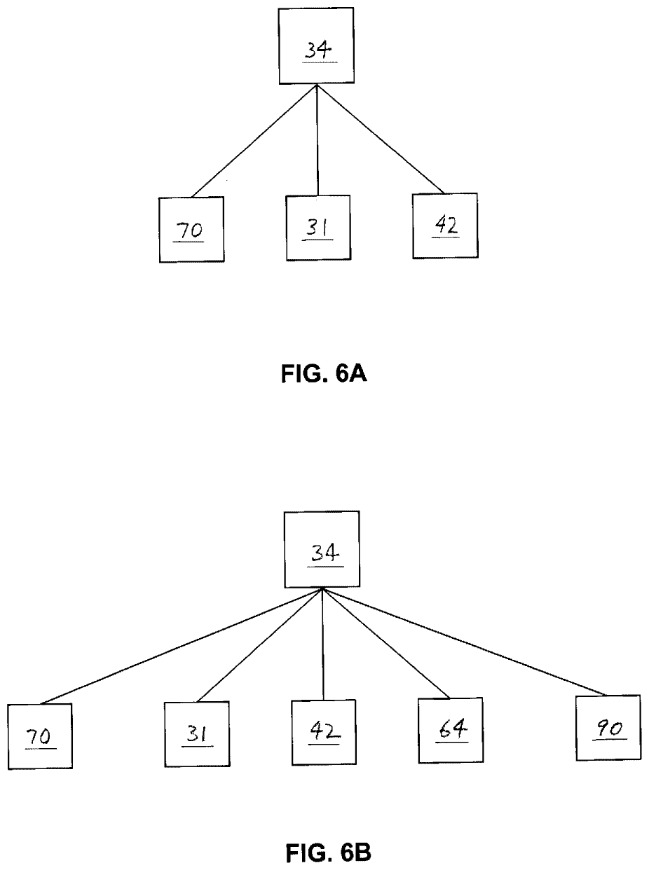

In one embodiment, the loader bucket 21 preferably is included in a loader 32 (FIG. 5). The system 20 preferably includes a controller 34 (FIGS. 1A, 6A, 6B). The controller 34 may be located in any suitable location, however, it is preferred that the controller 34 is mounted in a cab 36 of the loader 32, so that an operator (not shown) may utilize the controller 34. It will be understood that the controller 34 is operably connected with a number of hydraulic cylinders and/or electric motors of the bucket assembly 22, as will be described. Only one hydraulic cylinder is shown in FIGS. 1A and 1C, for clarity of illustration.

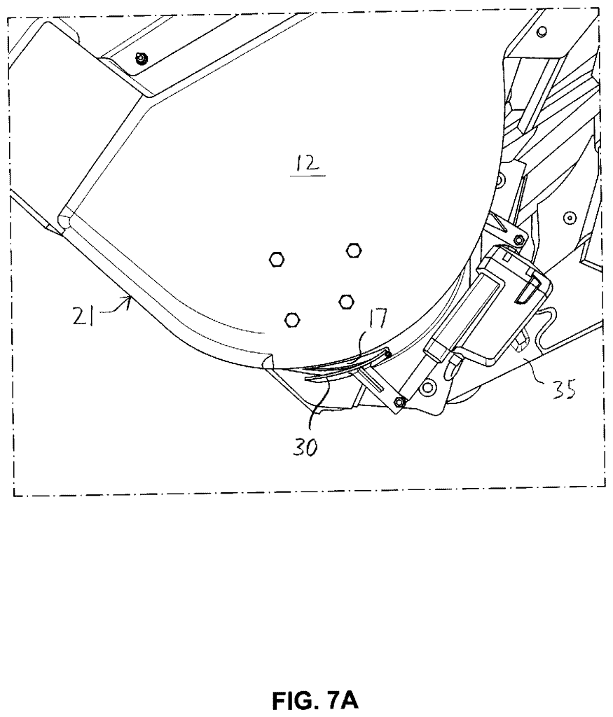

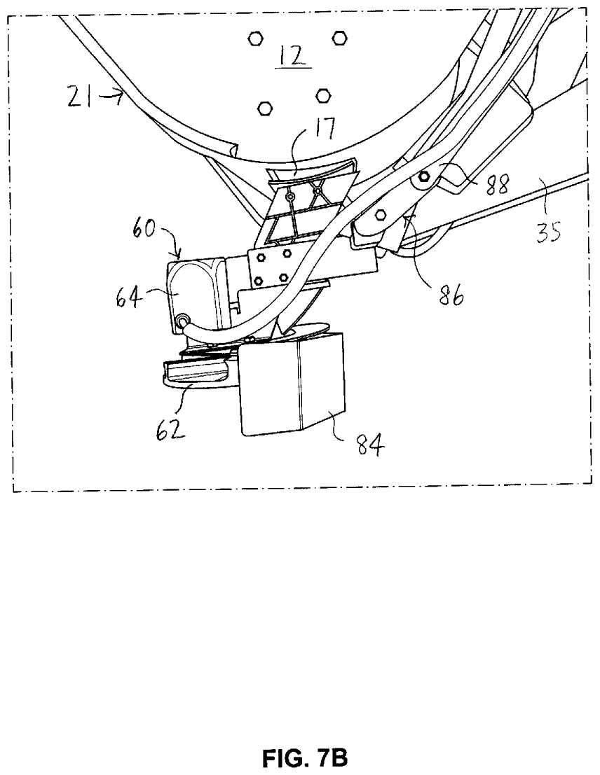

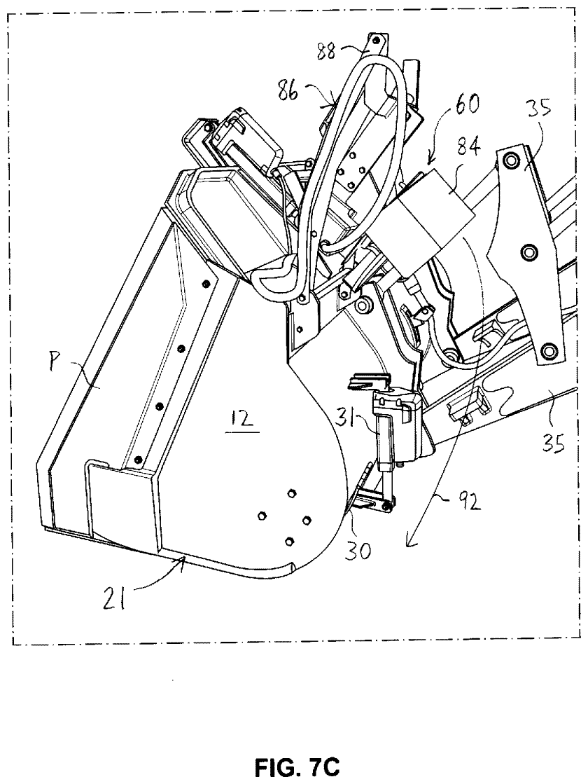

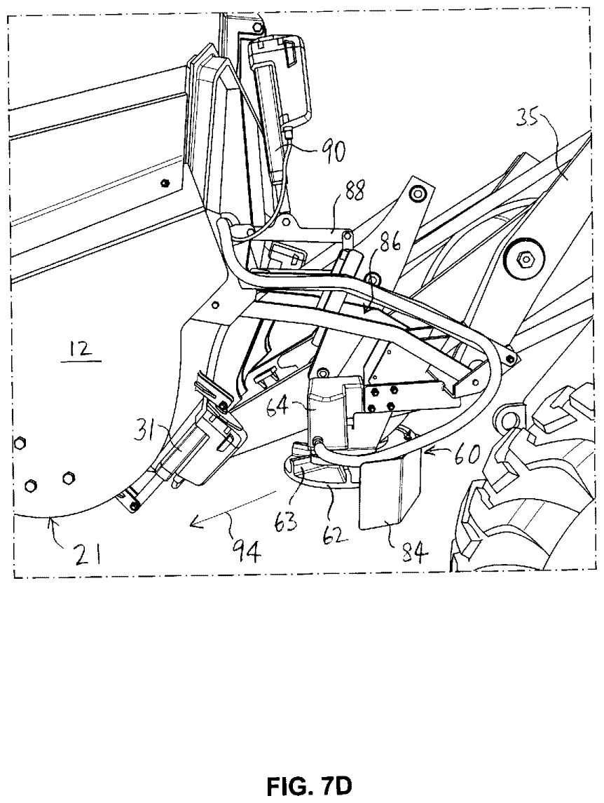

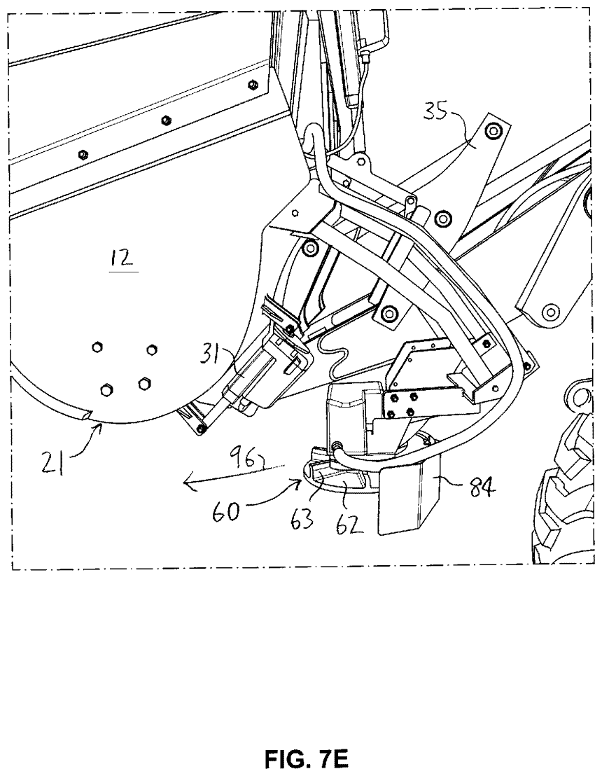

As can be seen, e.g., in FIGS. 5 and 7A-7E, the bucket 21 preferably is attached to the loader 32 using conventional attachment means 35. It will be understood that movement of the bucket 21 is effected by conventional means (e.g., hydraulic cylinders) that are controlled by the operator via a conventional loader bucket controller (not shown) that is independent of the system controller 34.

In the embodiment illustrated, panels “P” are included in the body 2 of the loader bucket 21, at different locations in the bucket. For example, the panels “P” preferably form parts of the sidewalls 10, 12 (FIGS. 3-5). In one embodiment, therefore, the body 2 preferably is not a conventional loader bucket body. As will be described, the panels “P” are formed to increase the bucket's carrying capacity.

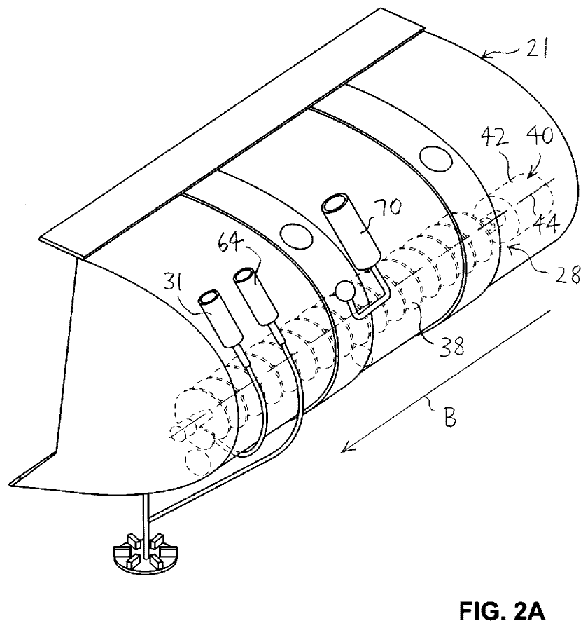

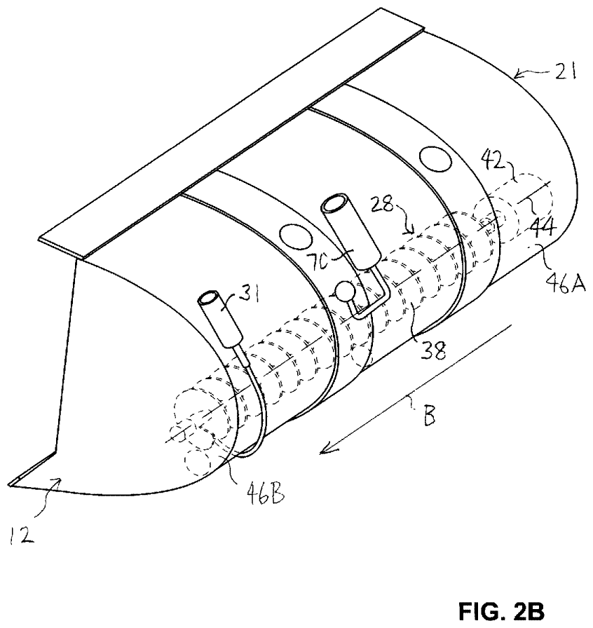

Preferably, the auger subassembly 28 includes an auger 38 and an auger motor subassembly 40. The auger motor subassembly 40 includes an auger motor 42 (FIGS. 2A, 2B, 6A, 6B) that is configured to rotate the auger 12 about an axis 44 of the auger 38 (FIGS. 2A, 2B). As indicated in FIGS. 2A and 2B, the auger 38 preferably is positioned to move flowable material in the heel portion 26, generally from a first side 46A thereof (i.e., adjacent to the sidewall 10) to a second side 46B thereof (i.e., adjacent to the sidewall 12), as indicated by arrow “B” in FIG. 2B.

Because those skilled in the art would be familiar with augers, further description thereof is unnecessary.

In one embodiment, the system preferably additionally includes a movement device 31 for moving the chute cover 30 between the closed and open positions thereof. Preferably, the movement device 31 is controlled via the controller 34. It is also preferred that the chute cover 30 is positionable in one or more intermediate positions between the closed and open positions, to limit flow of the flowable material through the chute 15 (FIGS. 7A, 7B).

In one embodiment, the system 20 preferably includes a floor element 48 having opposed inner and outer sides 50, 51 (FIGS. 1A, 1C). The floor element 48 preferably is movable between a lowered position thereof (FIG. 1A), in which the screen 24 is at least partially covered by the floor element 48 and the outer side 51 faces the open end 13 of the body 2, to partially define a carrying portion 52 of the bucket volume “VB”, and a raised position thereof (FIGS. 1C, 1F), in which the screen partially defines a main portion 54 of the bucket volume “VB”. In one embodiment, the floor element 48 is pivotably mounted to the body 2.

As can be seen in FIGS. 1C and 1F, the main portion 54 of the bucket volume “VB” is partially defined by respective outer wall parts 55, 56 of the upper and lower walls 6, 8, respective outer sidewall parts 57, 58 of the first and second sidewalls 10, 12, and the screen 24 (FIGS. 1F, 3). (It will be understood that, in FIG. 1F, a portion of the outer part 55 is covered by the raised floor element 48.) The outer wall parts 55, 56 and the outer sidewall parts 57, 58 are also parts of the internal surfaces 4. As can be seen in FIG. 1F, the main portion 54 is also partially defined by the open end 13 of the bucket 21. For convenience, the open end 13 is schematically represented by a dashed line indicating the shortest distance between respective outer ends “E₁”, “E₂” of the outer wall parts 55, 56 (FIG. 1F). It will be understood that the main portion 54 is also partially defined by the shortest distance between respective outer ends “E₃”, “E₄” of the outer sidewall parts 57, 58 (FIG. 3). However, those skilled in the art would appreciate that, in use, to the extent that the flowable material may form a pile thereof in the main portion 54, the volume of the flowable material actually located in the main portion 54 may extend past the open end of the bucket 21, as defined by the dashed line 13.

Those skilled in the art would appreciate that, when the floor element 48 is in its raised position, the heel portion 26 and the main portion 54 are in fluid communication, through the screen 24. As will be described, it is preferred that, when the floor element 48 is in its raised position and flowable material is in the main portion 54, the loader bucket 21 is positioned as shown in FIGS. 1C and 1F, so that any flowable material located in the main portion 54 is urged generally downwardly under the influence of gravity, causing the flowable material to flow through the screen 24 into the heel portion 26. As an example, the flowable material may flow from the main portion 54 through the screen 24 in the direction indicated by arrow “A”, into the heel portion 26 (FIG. 1C). Once the flowable material is in the heel portion 26, the flowable material preferably is moved by the auger subassembly 28, i.e., generally in the direction indicated by arrow “B” in FIG. 2B.

Those skilled in the art would appreciate that, in use, once the floor element 48 is in its raised position and the flowable material is in the main portion 54, the bucket 21 preferably is rotated or tipped by the operator utilizing the conventional loader controller, to position the outer chute opening 17 substantially vertically above the preselected location “L” (FIGS. 1C, 1F).

When the outer chute opening 17 is positioned vertically above the preselected location “L”, the chute cover 30 preferably is moved to its open position. The auger subassembly 28 then causes the flowable material that has moved past the screen 24 and into the heel portion 26 to move in the direction indicated by arrow “B” in FIGS. 2A and 2B, i.e., to the inner chute opening 16.

Preferably, as noted above, the flowable material that is in the heel portion 26 is movable by the auger subassembly 28 generally from the first side 46A of the heel portion 26 toward the second side 46B of the heel portion 26, as indicated by arrow “B” (FIG. 2B). In the examples illustrated, the inner chute opening 16 preferably is positioned at the second side 46B of the heel portion 26.

It will be understood that the preselected location “L” has a preselected area, and the outer chute opening 17 preferably is sized and formed to direct the flowable material onto the area of the preselected location “L”. Preferably, the cross-sectional area of the outer chute opening is generally less than or equal to the area of the preselected location “L”. Those skilled in the art would appreciate that the operator preferably positions the bucket 21 at a suitable height above the preselected location “L”, i.e., the bucket 21 preferably is positioned so that the flowable material exiting via the outer chute opening 17 is substantially limited to the preselected location “L”.

As can be seen in FIGS. 1A, 1B, when the chute cover 30 is in its closed position, the chute cover 30 preferably covers or blocks the outer chute opening 17.

In FIG. 1F, it can be seen that, in one embodiment, the bucket 21 preferably is positioned so that the outer chute opening 17 is located vertically above the preselected location “L”. Preferably, the chute cover 30 is in its closed position until the outer chute opening 17 is located above the preselected location “L”. The chute cover 30 is moved to in the open position thereof (as indicated by arrow “Y” in FIG. 1F), and the flowable material falls through the chute 15 and exits the chute via the outer chute opening 17 under the influence of gravity, as indicated by arrows “D” in FIG. 1F, onto the preselected location “L”.

As will be described, in the embodiment illustrated in FIG. 1C, the system 20 includes a spinner subassembly 60 with a rotatable platform 62 onto which the flowable material exiting the chute 15 is directed. As can be seen in FIG. 1C, when the chute cover 30 is in the open position thereof, the flowable material that is moved to the inner chute opening 16 falls through the chute 15 under the influence of gravity, as indicated by arrows “G”. Those skilled in the art would appreciate that the flowable material flowing through the chute 15 preferably forms a relatively well-defined stream of material, generally defined by the chute 15, and in particular, the outer chute opening 17.

In one embodiment, the floor element 48 preferably is attached to the internal surface 4 of the upper wall 6 by one or more hinges 68 (FIG. 3), about which the floor element 48 is pivotable. As can be seen in FIG. 1D, the movement of the floor element 48 preferably is effected by a device 70 that is connected with the floor element 48 via a floor element linkage 72 (FIGS. 1C, 1D, 3). The device 70 may be, for example, a suitable hydraulic cylinder, or a suitable electric motor. As will be described, the device 70 preferably is controlled by the operator via the controller 24.

The direction of movement of the floor element 48 from its lowered position to its raised position is indicated in FIG. 1A by arrow “F₁”. The direction of movement of the floor element 48 from its raised position to its lowered position is indicated in FIG. 1C by arrow “F₂”.

As can be seen in FIG. 1D, the device 70 preferably is mounted to the upper wall's external surface 18. The linkage 72 is partially positioned in a hole 74 that is formed in the upper wall 6 (FIG. 1D).

When the floor element 48 is in the lowered position, the carrying portion 52 of the bucket 26 is partially defined by the outer side 51 of the floor element 48, the respective outer parts 55, 56 of the upper and lower walls 6, 8 of the bucket 21, and the respective outer sidewall parts 57, 58 of the sidewalls 10, 12 (FIGS. 1A, 3). When the floor element 48 is in its lowered position, flowable material may be positioned in the carrying portion 52. Those skilled in the art would appreciate that the flowable material positioned in the carrying portion 52 may be moved by the loader 32 in the conventional manner, i.e., carried to the site as indicated in FIG. 5, at which the flowable material may be dumped out of the carrying volume 52 by pivoting the modified bucket 26 to allow the flowable material to exit from the carrying portion 52 via the open end 13 of the body 2, under the influence of gravity. The flowable material illustrated in the carrying portion 52 in FIG. 5 is identified by reference character 59.

Those skilled in the art would appreciate that, in use, to the extent that the flowable material may form a pile thereof in the carrying portion 52, the volume of the flowable material actually located in the carrying portion 52 may extend past the open end of the bucket 21, as defined by the dashed line 13.

From the foregoing, it can be seen that, when the floor element 48 is in the lowered position, the bucket 21 may be utilized in substantially the same manner as a conventional loader bucket, i.e., to carry material or an object in the carrying portion 52. However, those skilled in the art would appreciate that, when the floor element 48 is in its lowered position, the portion of the bucket's volume that is located below the floor element 48 (i.e., including the heel portion 26) is unavailable, i.e., the carrying capacity of the bucket is decreased by approximately the heel portion 26, when the floor element 48 is in the lowered position thereof.

Preferably, the panels “P” are included in the bucket 21 to enable more material to be carried in the carrying portion 52, to at least partially compensate for the loss of a part of the bucket's carrying capacity when the floor element 48 is in its lowered position. As can be seen in FIGS. 3-5 and 7C, the panels “P” may be included, for example, in the sidewalls 10, 12 and in the lower wall 8.

From the foregoing, it can be seen that the system 20 may be used to distribute a variety of materials, to one or more preselected locations “L”. For example, the flowable material may be sand, or gravel. In one embodiment, the system 20 may be used to fill sand bags. In these circumstances, the sand bag to be filled (not shown) is positioned vertically below the outer chute opening 17, i.e., the open sand bag is in the preselected location “L”. Alternatively, the system 20 may be utilized, for example, to distribute washed gravel between a foundation and a wall of the excavated hole in which the foundation is located. Those skilled in the art would appreciate that the screen 24 that is used preferably is selected to have openings therein suitable for the flowable material that is to be distributed.

As other examples, the flowable material may be road salt or sand which is intended to be distributed over a travelled surface, e.g., a street, or a parking lot, in cold weather.

Those skilled in the art would appreciate that, in certain circumstances, it may be desirable to laterally distribute the flowable material, after the flowable material exits from the outer chute opening 17 under the influence of gravity.

As can be seen in FIG. 1C, in one embodiment, the system 20 preferably additionally includes the spinner subassembly 60 for laterally distributing the flowable material that exits from the chute 15. It is preferred that the spinner subassembly 60 includes the platform 62 and a spinner device 64 (FIG. 7B), e.g., a suitable motor, for rotating the platform 62 about an axis 66 thereof.

The spinner subassembly 60 preferably is for laterally distributing the flowable material (e.g., road salt or sand) on the travelled surface. Preferably, the spinner subassembly 60 is positionable relative to the bucket 21 to locate the platform 62 below the outer chute opening 17, so that the flowable material exiting the chute 15 falls onto the platform 62, while the platform 62 rotates about its axis 66. As can be seen in FIG. 1C, the platform 62 preferably is positioned partially vertically below the outer chute opening 17, so that while rotating, a part of the platform 62 is in the preselected location “L”. Those skilled in the art would appreciate that the flowable material (e.g., road salt, or sand) exiting from the chute 15 under the influence of gravity falls onto the rotating platform 62. Preferably, the platform 62 is rotating, and so the flowable material that falls onto the platform 62 is quickly thrown laterally by the platform 62, due to the rotation of the platform 62. The platform 62 preferably includes vanes 63 thereon, for engaging the flowable material (FIG. 1C).

In FIG. 1C, the rotation of the platform 62 about its axis 66 is indicated by arrows “C”. The directions in which the flowable material is thrown laterally by the platform 62 are generally indicated by arrows “X₁”, “X₂” in FIG. 1C. The travelled surface is identified in FIG. 1C by reference character “T”.

As can be seen in FIG. 7B, in one embodiment, the spinner subassembly 60 preferably includes a shield element 84 formed to prevent the flowable material that is flung off the platform 62 from being directed generally backwards (i.e., toward the cab 36).

In one embodiment, the spinner subassembly 60 preferably is mounted in a spinner carriage subassembly 86 that includes a frame 88 that is movable between a fully lowered position (FIG. 7B), in which the platform 62 is partially located beneath the outer chute opening 17, and a fully raised position (FIG. 7C), in which the spinner subassembly 60 is inoperable.

As can be seen in FIG. 7C, when the frame 88 is in its fully raised position, the spinner subassembly 60 is located so that it does not interfere with operation of the bucket 21 when the floor element 48 is lowered, or with operation of the system 20 when the spinner subassembly 60 is not utilized.

The movement of the frame 88 of the spinner carriage subassembly 86 from its fully raised position to its fully lowered position can be seen in FIGS. 7C-7E, and 7B. The frame 88 is formed to be moved by a suitable hydraulic cylinder or electric motor 90 in the direction indicated by arrow 92 in FIG. 7C to the frame's first intermediate position, which is shown in FIG. 7D. Next, the cylinder or motor 90 is operated to cause the frame 88 to move in the direction indicated by arrow 94 to the frame's second intermediate position (FIG. 7E). Finally, the cylinder or motor 90 is operated to cause the frame 88 to move in the direction indicated in FIG. 7E by arrow 96 to the frame's fully lowered position, which is shown in FIG. 7B. It will be understood that the frame 88 and the cylinder or motor 90 are omitted from FIG. 2A for clarity of illustration.

Those skilled in the art would appreciate that the elements of the bucket assembly 22 that are movable may be moved by any suitable means for movement, e.g., hydraulic cylinders or electric motors, or combinations thereof. As schematically illustrated in FIGS. 6A and 6B, the controller 34 preferably controls the respective means for movement separately. Those skilled in the art would be aware of suitable controllers.

For example, in the embodiment schematically illustrated in FIG. 6A, the controller 34 is operably connected with the hydraulic cylinder or motor 70 for moving the floor element 48 between the floor element's raised and lowered positions, as described above. Preferably, the controller 34 also is operably connected with a hydraulic cylinder or motor 31 (FIGS. 7A, 7C-7E) for opening and closing the chute cover 30. It is also preferred that the controller 34 is operably connected with the auger motor 42, which may be electric or hydraulic (FIGS. 6A, 6B).

In another embodiment, schematically illustrated in FIG. 6B, the controller 34 is operably connected with the hydraulic cylinders 84, 86 and with the auger motor 42, and the controller 24 is also operably connected with hydraulic cylinders or electric motors 64, 90 that are respectively included in the spinner subassembly 60 (i.e., for rotating the platform 62), and included also in the spinner carriage subassembly 86 (i.e., for raising and lowering the frame 88).

In use, when the floor element 48 is in its lowered position, the bucket 21 may be used generally as a conventional loader bucket, e.g., to carry a flowable material to a location at a work site where the flowable material is to be distributed. That is, when the floor element 48 is in the lowered position, flowable material may be loaded into the carrying portion 52 and the bucket 21 may be used to carry the flowable material to the site, e.g., to form a stockpile. For example, if washed stone (e.g., ⅜ inch nominal diameter, or ⅝ inch) is to be distributed in or around a foundation, then a stockpile of the washed stone may be formed at the site, using the bucket 21 with the floor element 48 in its lowered position.

When the bucket 21 is empty, the floor element 48 may then be moved to its raised position, and the main portion 54 may then be loaded with the flowable material, which flows through the screen 24 into the heel portion 26. When the chute cover 30 is removed from the outer chute opening 17, the chute 15 is open, and the auger subassembly 28 preferably moves the flowable material that is in the heel portion 26 to the open chute 15, through which the flowable material exits the heel portion 26 to the preselected location “L”, e.g., in or around a foundation.

In connection with snow removal and salting or sanding travelled surfaces during winter months, first, when the floor element 48 is in its lowered position, the bucket 21 may be used, for instance, to remove snow in the conventional manner from the travelled surface (e.g., a parking lot) that is to be cleared, and on which the salt or sand is to be distributed. Also, with the floor element 48 in its lowered position, salt or sand may be carried in the carrying portion 52, to create a stockpile at the site. Once the snow has been removed, the floor element 48 preferably is moved to its raised position, and a load of flowable material (e.g., road salt, or sand) is then loaded into the main portion 54. The spinner carriage subassembly 86 is then moved to its fully lowered position, to locate the platform 62 below the outer chute opening 17, so that the spinner subassembly 60 may be used to spread the salt or sand on the travelled surface.

As described above, the salt or sand flows through the screen 24 into the heel portion 26, under the influence of gravity. Preferably, the chute cover 30 remains closed while the flowable material is positioned in the main portion 54, and also while the bucket 21 is moved into position, and while the spinner subassembly 60 is moved into position to locate the platform 62 below the outer chute opening 17. The movement of the chute cover 30 to its open position is indicated by arrow “Y” in FIG. 1C. When the chute cover 30 is open, the auger subassembly 28 may move the salt or sand along the heel portion 26 to the inner chute opening 16, through which the salt or sand exits from the heel portion 26 via the chute 15 under the influence of gravity, to fall onto the rotating platform 62, which laterally directs the flowable material onto the travelled surface.

In one embodiment, the invention includes a method for controlling movement of flowable material from the bucket 21 to the one or more preselected locations “L”. Preferably, the chute 15 is formed in the body 2 to allow the flowable material to exit from the bucket volume the preselected location “L”. Next, the bucket assembly 22 is provided and mounted to the body 2.

With the floor element 48 in its raised position, flowable material preferably is positioned in the main portion 54. The flowable material is allowed to flow through the screen 24 and into the heel portion 26, under the influence of gravity. Preferably, the bucket 21 is positioned to align the outer chute opening 17 with the preselected location “L”.

Next, the chute cover 30 is moved to the open position thereof, to allow the flowable material to flow through the chute 15 under the influence of gravity. With he auger subassembly 28, the flowable material is moved to the inner chute opening 16.

The flowable material is allowed to exit the heel portion 26 via the chute 15 under the influence of gravity, to position the flowable material at the preselected location “L”.

It will be appreciated by those skilled in the art that the invention can take many forms, and that such forms are within the scope of the invention as claimed. The scope of the claims should not be limited by the preferred embodiments set forth in the examples, but should be given the broadest interpretation consistent with the description as a whole.

I claim:

1. A system for directing flowable material to at least one preselected location, the system comprising:
a loader bucket comprising a body having at least one internal surface thereof defining a bucket volume, the body comprising upper and lower walls connected with first and second sidewalls defining an open end and an opposed closed end of the body,
the body comprising a chute located at the closed end and extending between inner and outer chute openings at said at least one internal surface and an opposed external surface of the body respectively, the outer chute opening having a preselected cross-sectional area sized for delivery of the flowable material therefrom to said at least one preselected location;
a bucket assembly mounted to the loader bucket, the bucket assembly comprising:
a screen positioned in the body defining a heel portion of the bucket volume between the screen and said at least one internal surface of the body at the closed end;
an auger subassembly at least partially located in the heel portion, for moving the flowable material that is positioned in the heel portion to the inner chute opening; and
a chute cover movable between a closed position thereof, in which the chute cover prevents the flowable material from flowing through the chute, and an open position thereof, in which movement of the flowable material through the chute is permitted thereby.

2. The system according to claim 1 in which the chute cover is positionable in at least one intermediate position between the closed and open positions, to limit flow of the flowable material through the chute.

3. The system according to claim 1 additionally comprising a movement device for moving the chute cover between the closed and open positions.

4. The system according to claim 1 additionally comprising a floor element having opposed inner and outer sides, the floor element being movable between a lowered position thereof, in which the screen is at least partially covered by the floor element and the outer side faces the open end, to partially define a carrying portion of the bucket volume, and a raised position thereof, in which the screen partially defines a main portion of the bucket volume.

5. The system according to claim 4 in which the main portion of the bucket volume is partially defined by respective outer wall parts of the upper and lower walls, respective outer sidewall parts of the first and second sidewalls, and the screen.

6. The system according to claim 4 in which the floor element is pivotably mounted to the body.

7. The system according to claim 3 additionally comprising a spinner subassembly for laterally distributing the flowable material that exits from the chute.

8. The system according to claim 7 in which the spinner subassembly comprises a platform and a spinner device for rotating the platform about an axis thereof.

9. A bucket assembly to be mounted in a loader bucket having a body that defines a bucket volume therein, the bucket assembly comprising:
a screen positioned in the body to define a heel portion of the bucket volume located between the screen and at least one internal surface of upper and lower walls of the body;
a chute cover movable between a closed position thereof, in which the chute cover prevents flowable material from flowing through a chute that is formed in a closed end of the body, and an open position thereof, in which the chute is in fluid communication with the heel portion, and the flowable material moves from the heel portion through the chute; and
an auger subassembly at least partially located in the heel portion, for moving flowable material positioned in the heel portion to the chute.

10. The bucket assembly according to claim 9 in which the chute cover is positionable in at least one intermediate position between the open and closed positions, to limit flow of the flowable material through the chute.

11. The bucket assembly according to claim 9 additionally comprising a movement device for moving the chute cover between the closed and open positions.

12. The bucket assembly according to claim 9 additionally comprising a floor element having opposed inner and outer sides mounted to the body, the floor element being movable between a lowered position thereof, in which the screen is at least partially covered by the floor element and the outer side faces an open end of the body, to partially define a carrying portion of the bucket volume, and a raised position thereof, in which the screen partially defines a main portion of the bucket volume, and the heel portion and the main portion are in fluid communication with each other.

13. The bucket assembly according to claim 12 in which the main portion of the bucket volume is partially defined by respective outer wall parts of the upper and lower walls, respective outer parts of first and second sidewalls of the loader bucket, and the screen.

14. The bucket assembly according to claim 12 in which the floor element is pivotably mounted to the body.

15. The bucket assembly according to claim 9 additionally comprising a spinner subassembly for laterally distributing the flowable material that exits from the chute.

16. A method for controlling movement of flowable material from a loader bucket having a body including internal surfaces defining a bucket volume thereof to at least one preselected location, the method comprising:
a. forming a chute in the body to allow the flowable material to exit from the bucket volume to said at least one preselected location;
b. providing a bucket assembly to be mounted to the body, the bucket assembly comprising:
a screen positioned in the body to define a heel portion of the bucket volume between the screen and the internal surfaces;
an auger subassembly at least partially located in the heel portion, for moving the flowable material positioned in the heel portion toward the chute;
a chute cover movable between a closed position thereof, in which the chute cover prevents the flowable material from flowing through the chute, and an open position, in which movement of the flowable material through the chute is unimpeded thereby;
c. positioning the flowable material in the loader bucket;
d. allowing the flowable material in the loader bucket to flow through the screen and into the heel portion under the influence of gravity;
e. positioning the loader bucket to align the chute with said at least one preselected location;
f. moving the chute cover to the open position thereof, to allow the flowable material to flow through the chute under the influence of gravity;
g. with the auger subassembly, moving the flowable material toward the chute; and
h. allowing the flowable material to exit the heel portion via the chute under the influence of gravity, to position the flowable material at said at least one preselected location.
